(19) United States
(12) Patent Application Publication
(10) Pub. No.: US 2009/0303592 A1
(43) Pub. Date: Dec. 10, 2009

(54) RETROREFLECTOR

(76) Inventor: John Peter Oakley, Manchester (GB)

Correspondence Address: BAKER & DANIELS LLP, 300 NORTH MERIDIAN STREET, SUITE 2700, INDIANAPOLIS, IN, 46204, US

(21) Appl. No.: 12/307,637

(22) PCT Filed: Jun. 15, 2007
(86) PCT No.: PCT/GB07/02253

§ 371 Date: Jan. 6, 2009

(30) Foreign Application Priority Data
Jul. 11, 2006 (GB) 0613737.6

(51) Int. Cl. G02B 5/126

(52) U.S. Cl. 359/534

(57) ABSTRACT

Compensation for spherical aberration in retroreflectors to improve the retroreflector performance. A retroreflector has at least two concentric spherical layers. A first of the layers is of uniform refractive index n! surrounding a second of the layers of uniform refractive index n₂. The refractive indices satisfy the criteria n₁>n₂. A retroreflector is formed as a sphere having a predetermined refractive index and radius, such that spherical aberration of incident radiation is at least partially compensated for by primary defocus.

The present invention relates to retroreflectors, and to methods of manufacture and use of such retroreflectors. Embodiments of the present invention are particularly suitable for, but not limited to, providing a retroreflector having both a large acceptance angle and a relatively large scattering cross-section.

A retroreflector is a device that reflects incident light or other electromagnetic radiation from a source back towards the source. Retroreflectors function over a range of angles of incidence, in contrast to plane mirrors, which only function as retroreflectors if the mirror is exactly perpendicular to the incident light beam. The acceptance angle is the range of incident angles over which the retroreflector will reflect light or other radiation back from where it came.

Retroreflectors are utilised in a range of applications, particularly for providing positional information. For example, cats-eye retroreflectors located along the centre of a road-surface provide a convenient reference for vehicle drivers at night. Retroreflectors are also utilised in electronic distance measurement and object tracking over a variety of ranges. Typically, lasers are utilised to provide a collimated incident beam for reflection by the retroreflector, which ideally provides a collimated return beam. To maximise the range of operation of the apparatus, it is desirable that the retroreflector provides efficient reflection of the incident beam.

Two broad categories of retroreflector are commonly used: retroreflectors formed of corner-cube mirrors or prisms, and cats-eye retroreflectors.

A corner-cube mirror or prism provides an almost perfect collimated return beam, but typically provides a limited angle of operation (acceptance angle) e.g. +/−10° at a loss of −3 dB for a corner cube mirror retroreflectors, and +/−15° at a loss of −3 dB for a typical glass prism. As described within the article by Handerek V. and Laycock L. “Feasibility of retroreflective free-space optical communication using retroreflectors with very wide angle of view”, in “Advanced Free-Space Optical Communication Techniques and Technologies (Ross M and Scott A. M. Eds.)”, Proceedings of SPIE Vol. 5614, 2004, such corner-cube devices suffer from greatly reduced performance at larger angles.

In many applications it is desirable to utilise a device having a much larger acceptance angle, so that the retroreflector may be targeted from a range of different positions. Example applications include free-space optical communications, electronic distance measurement (particularly building and construction surveys) and laser tracking.

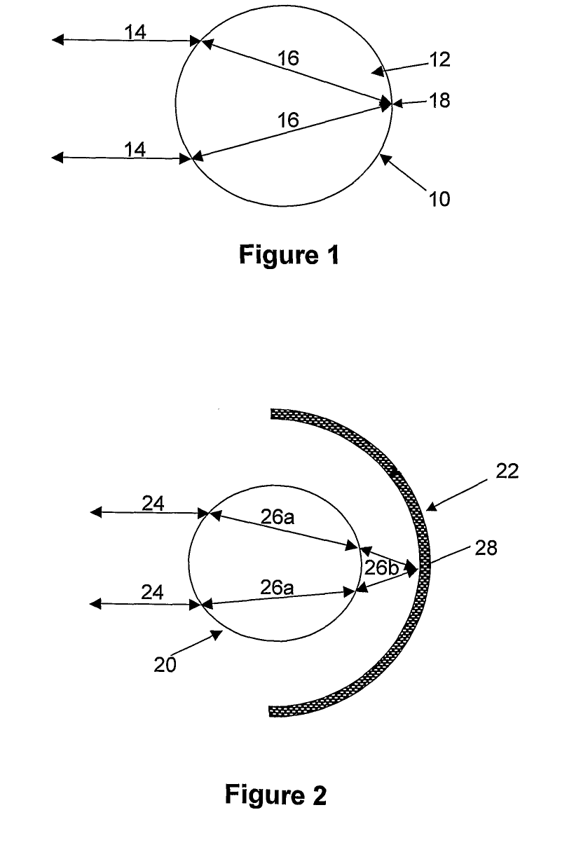

A cats-eye retroreflector has a wide viewing or acceptance angle. The article by Takatsuji et. al. “Whole viewing angle cat's eye retroreflector as a target for laser trackers”, Measurement Science and Technology, Vol 10, pp N87-N90, 1999, describes a spherical retroreflector. FIG. 1 illustrates that retroreflector. The retroreflector 10 is a 50 mm diameter sphere (ball lens) 12 formed of a glass material having a refractive index of almost 2 at a laser wavelength of 632.8 nm (in air). In use, a collimated beam 14 is directed at the retroreflector 10. Due to the curvature of the sphere, the incident collimator beam 14 is converged 16 to a spot/small region on the far side 18 of the ball lens 12 from the incident beam 14. The relatively high refractive index of the ball lens material means that a significant amount of light (approximately 9%) is reflected back towards the source (i.e. returns along the same path 16, 14 as the incident beam). The article indicates that the reflection performance can be increased to almost 15% by adding a part-reflective coating to the spherical surface. While such a device provides a useful wide viewing angle, it is technically difficult to make material of such a high refractive index with good optical homogeneity. The cost of producing such a device is therefore likely to render the device unsuitable for many commercial applications.

The article by Handerek V, McArdle H. Willats T., Psaila N. and Laycock L. “Experimental Retroreflectors with very wide Field of View for Free-Space Optical Communications”, 2nd EMRS DTC Technical Conference, Edinburg 2005, describes how a retroreflector can be formed using a ball lens of lower refractive index (i.e. potentially cheaper) material. FIG. 2 indicates the retroreflector which comprises a ball lens 20 positioned within a hemispherical reflector 22. In use, an incident collimated beam 24 is converged 26a, 26b via the ball lens 20 to a small region 28 on the reflector 22, which then reflects the beam back along the incident path (26b, 26a, 24). It will be appreciated that, due to the presence of the hemispherical reflector 22, the retroreflector illustrated in FIG. 2 will have a lower acceptance angle than the retroreflector illustrated in FIG. 1.

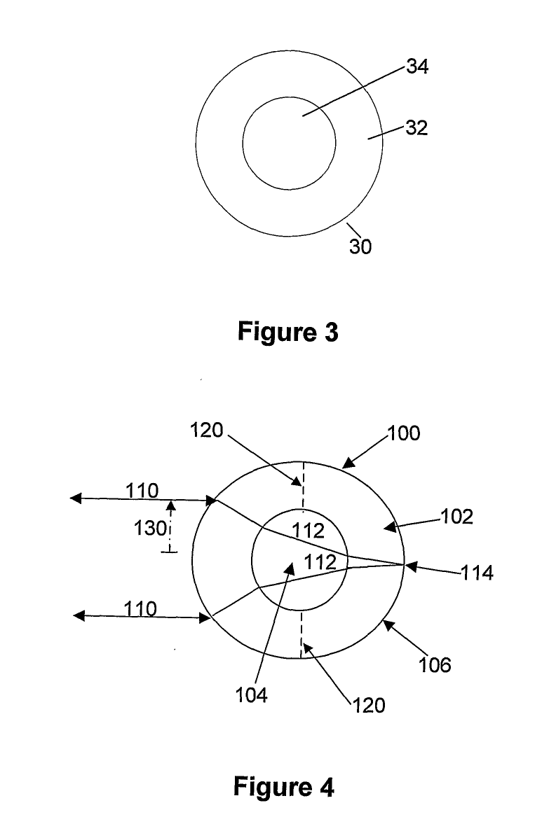

The article by Burmistrov V. B. et al., “Spherical Retroreflector with an Extremely Small Target Error: International Experiment in Space”, 11th International Workshop on Laser Ranging, Deggendorf, Germany, 21-25 Sep. 1998, describes a multi-layer spherical retroreflector. FIG. 3 is a schematic diagram of the retroreflector 30, which has an outer diameter of 60 mm. The retroreflector 30 consists of two concentric layers 32, 34. The outer layer 32 has a refractive index of approximately 1.47, and the inner layer 34 (which is shaped as a sphere) has a higher refractive index of approximately 1.75 (refractive indices measured at the operational wavelength of 532 nm). The article describes how such a retroreflector is suitable for providing precision measurements of the orbit of satellites.

It is an aim of embodiments of the present invention to provide a retroreflector that addresses one or more of the problems of the prior art, whether described herein or otherwise. It is an aim of a particular embodiment of the present invention to provide a retroreflector that provides a relatively high efficiency return signal over a wide range of acceptance angles.

In a first aspect, the present invention provides a retroreflector comprising at least two concentric spherical layers, a first of said layers being of uniform refractive index n₁ surrounding a second of said layers of uniform refractive index n₂, wherein the refractive indices satisfy the criteria n₁>n₂.

The present inventor has appreciated that spherical aberration severely limits the performance of many prior art spherical retroreflectors. A retroreflector, in which the first (outer) layer has a higher refractive index than the second (inner) layer, provides a curved surface (formed between the layers) having a negative power. The inventor has appreciated that such a curved surface can be utilised to compensate for spherical aberration, thus allowing a significant increase in the performance of the retroreflector. The layers can be arranged to provide either partial or full correction of spherical aberration, depending upon the desired application. Such retroreflectors can be formed from materials having a refractive index significantly less than 2 i.e. allowing the use of relatively cheap materials to provide relatively efficient retroreflectors having large angles of acceptance.

The second layer may be a sphere.

Said concentric spherical layers may provide a negative optical power to incident radiation of a predetermined wavelength to compensate for spherical aberration.

The retroreflector may further comprise a reflective coating of predetermined thickness located on the external surface of the outermost of said layers.

The retroreflector may further comprise a partially-reflective coating of predetermined thickness extending uniformly around the complete outer surface of the outermost of said layers.

Said concentric spherical layers may be dimensioned such that collimated radiation incident on an outer surface of the retroreflector at a first position is brought to a focus on an outer surface of the retroreflector at a second position opposite to the first position.

Said first and second positions may be located on the external surface of the outermost of said layers.

The retroreflector may further comprise a concave reflective surface positioned a predetermined distance from the outermost concentric layer.

Said concave reflective surface may be a hemispherical reflector having a radial centre concentric with said spherical layers.

Said second position may be located on concave reflective surface.

Said at least two concentric spherical layers may consist only of first and second layers, the first layer having an external radius of r₁ and the second layer having an external radius of r₂, which satisfy the criteria

$$\frac{2}{{n}_{1}} + \frac{2 {r}_{1}}{{r}_{2} {n}_{2}} - \frac{2 {r}_{1}}{{r}_{2} {n}_{1}} \approx 1$$

$$and \\ - \frac{1}{16 {r}_{1}^{3} {n}_{1}} + \frac{1}{16 {r}_{1}^{3}} + \frac{1}{8 {r}_{2}^{3} {n}_{1} {n}_{2}} - \frac{1}{8 {n}_{2}^{2} {r}_{2}^{3}} \approx 0.$$

The retroreflector may further comprise a third of said layers having a uniform refractive index n₃ surrounding the first of said layers, wherein the refractive indices satisfy the criteria n₁>n₂>n₃.

Said at least two concentric spherical layers may consist only of the first, second and third layers, the first layer having an external radius of r₁, the second layer having an external radius of r₂, and the third layer having an external radius of r₃, the refractive indices and radii of said layers being arranged to provide a predetermined degree of spherical aberration compensation.

The retroreflector may further comprise at least a third and a fourth of said concentric layers.

The retroreflector may have a scattering cross section of at least 5,000 m².

The retroreflector may comprise one or more surfaces with a total negative optical power of greater than 10% of the total positive power.

Said criteria may be satisfied for at least two different wavelengths of incident radiation.

The materials forming said layers may substantially satisfy the athermal condition over a predetermined temperature range.

The retroreflector may further comprise an optical modulator arranged to modulate incident radiation.

According to the second aspect of the present invention there is provided a method of manufacturing a retroreflector comprising at least two concentric spherical layers, the method comprising:

providing a first spherical layer of uniform refractive index n₁ around a second spherical layer of uniform refractive index n₂, wherein the refractive indices satisfy the criteria n₁>n₂.

The method may further comprise the steps of:

calculating the radii and refractive indices of said concentric layers required to provide a predetermined degree of at least one of spherical aberration compensation and scattering cross-section; and

forming the layers having the calculated radii and refractive indices.

According to a third aspect of the present invention there is provided a method of operation of a retroreflector comprising at least two concentric spherical layers, a first of said layers being of uniform refractive index n₁ surrounding a second of said layers of uniform refractive index n₂, wherein the refractive indices satisfy the criteria n₁>n₂, the method comprising:

directing a radiation beam to reflect from the retroreflector; and

measuring a predetermined property of the radiation beam reflected from the retroreflector.

According to a fourth aspect of the present invention there is provided a retroreflector comprising a sphere having a predetermined refractive index and radius such that spherical aberration is at least partially compensated for by primary defocus.

The present inventor has realised that the performance of single layer spherical retroreflector devices can be improved by selecting the radius of the device such that spherical aberration of the device is corrected by primary defocus i.e. such that the optical performance of the retroreflector is actually enhanced by spherical aberration. This allows the provision of simple, but relatively cheap retroreflectors (i.e. formed of materials have a refractive index less than two), that have reasonable performance and wide acceptance angles.

The sphere may be formed of S-LAH79 optical glass.

The sphere may have a radius of less than 6 mm.

The sphere may have a scattering cross-section of at least 5 m².

According to a fifth aspect of the present invention there is provided a method of manufacturing a retroreflector comprising a sphere, the method comprising:

designing a sphere to have a predetermined refractive index and radius such that spherical aberration is at least partially compensated for by primary defocus; and

manufacturing the designed sphere.

According to a sixth aspect of the present invention there is provided a method of operation of a retroreflector comprising a sphere having a predetermined refractive index and radius such that spherical aberration is at least partially compensated for by primary defocus, the method comprising:

directing a radiation beam to reflect from the retroreflector; and

measuring a predetermined property of the radiation beam reflected from the retroreflector to determine the position of the retroreflector.

According to a seventh aspect of the present invention there is provided a spherical retroreflector, comprising at least one concentric spherical layer, the values of the refractive index and radius of each of said at least one layer correcting for spherical aberration within the retroreflector for incident radiation of predetermined wavelength. Embodiments of the present invention will now be described, by way of example only, with reference to the accompanying drawings, in which:

FIG. 1 is a schematic diagram of a known spherical retroreflector in the form of a ball lens;

FIG. 2 is a schematic diagram of a further known retroreflector including a ball lens and a hemispherical mirror;

FIG. 3 is a schematic diagram of a known type of spherical retroreflector including two layers of different refractive index;

FIG. 4 illustrates a spherical retroreflector including two layers of different refractive index in accordance with an embodiment of the present invention;

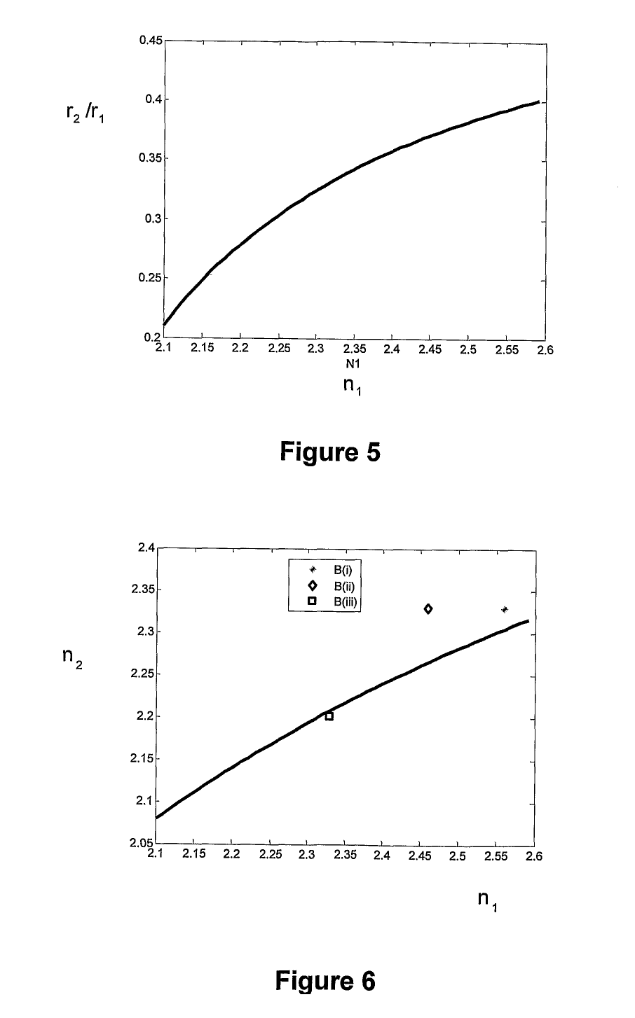

FIG. 5 is a graph illustrating the ideal ratio of the radii of the two layers as a function of refractive index of the outer layer, for the embodiment illustrated in FIG. 4;

FIG. 6 is a graph indicating the ideal values of refractive index of the two layers of the embodiment illustrated in FIG. 4, with the three marked points corresponding to example devices formed using real materials;

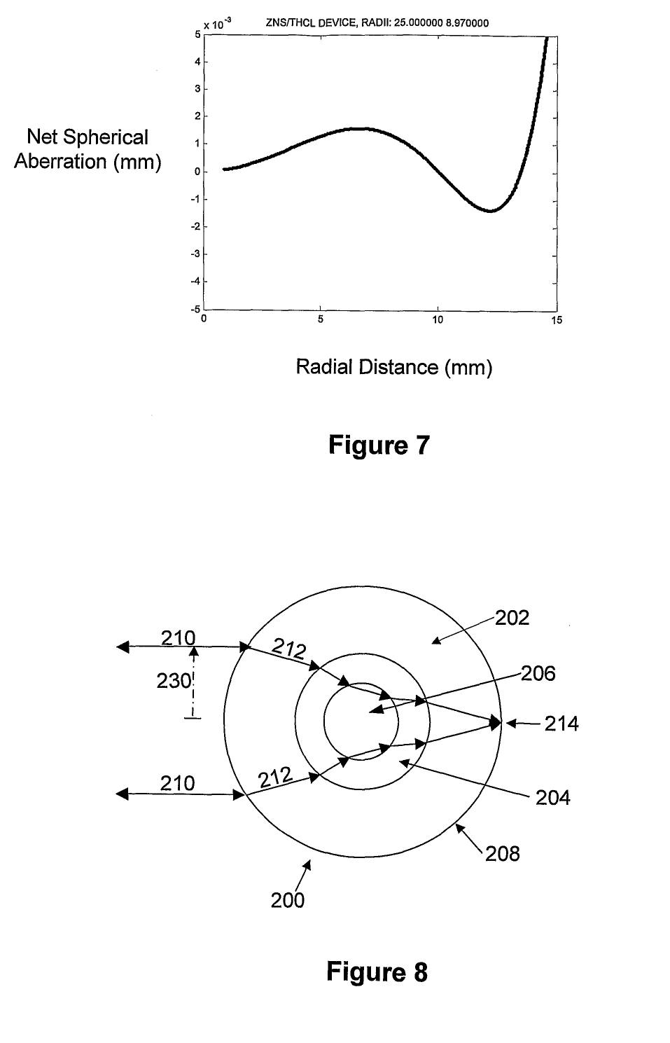

FIG. 7 is a graph illustrating the spherical aberration as a function of radial distance for the example marked B(iii) in FIG. 6;

FIG. 8 is a schematic diagram of a three-layer retroreflector in accordance with an embodiment of the present invention;

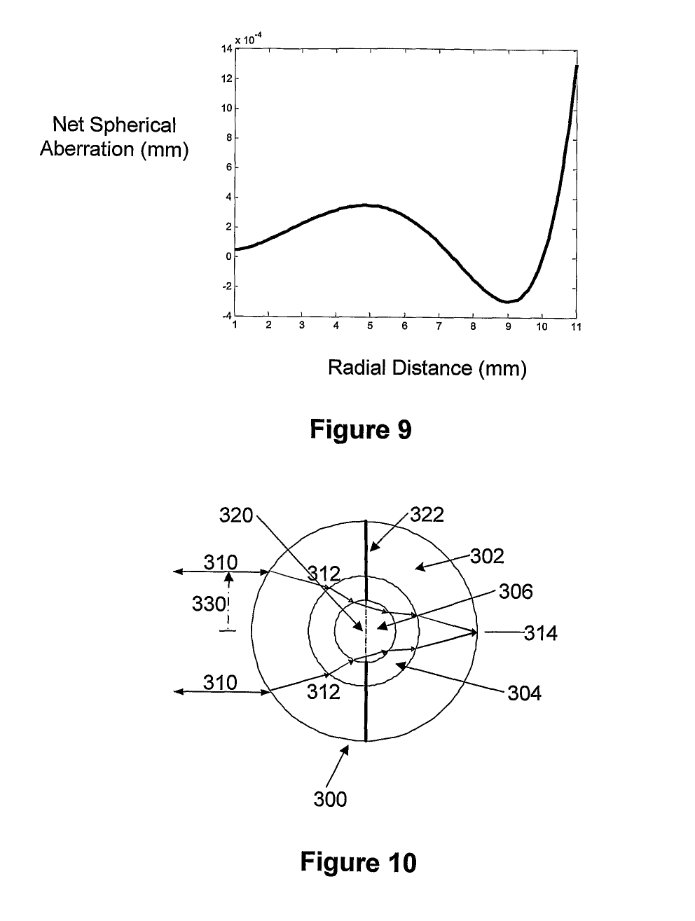

FIG. 9 is a graph indicating the spherical aberration as a function of radial distance across a collimated input beam for an example three-layer retroreflector formed in accordance with the embodiment illustrated in FIG. 8;

FIG. 10 is a schematic diagram of a three-layer retroreflector arranged for operation at two different wavelengths, formed in accordance with an embodiment of the present invention.

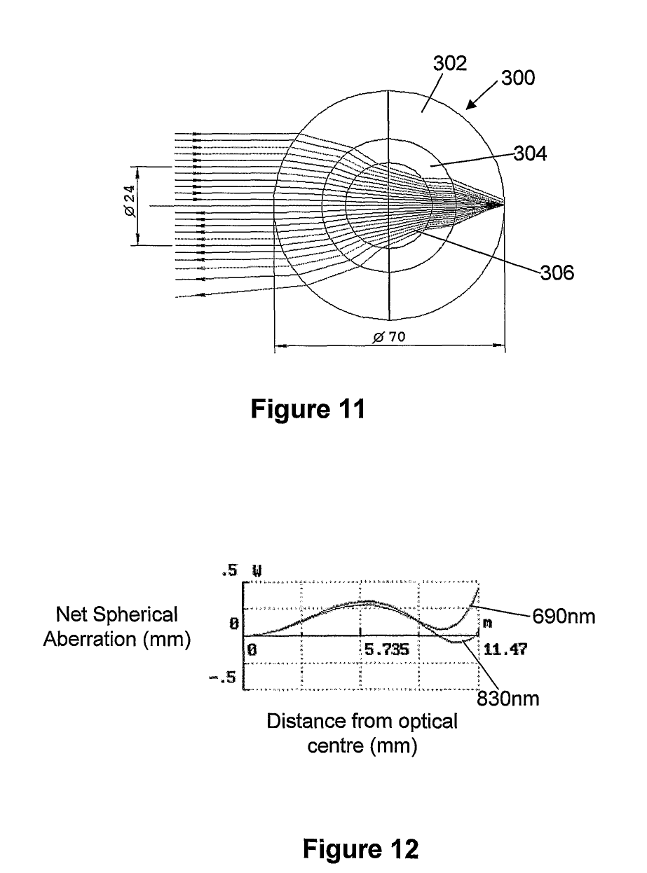

FIG. 11 is a ray trace diagram of the three-layer achromat retroreflector illustrated in FIG. 10;

FIG. 12 indicates the spherical aberration as a function of distance from the optical centre of a collimated input beam for the three-layer achromat retroreflector illustrated in FIG. 10;

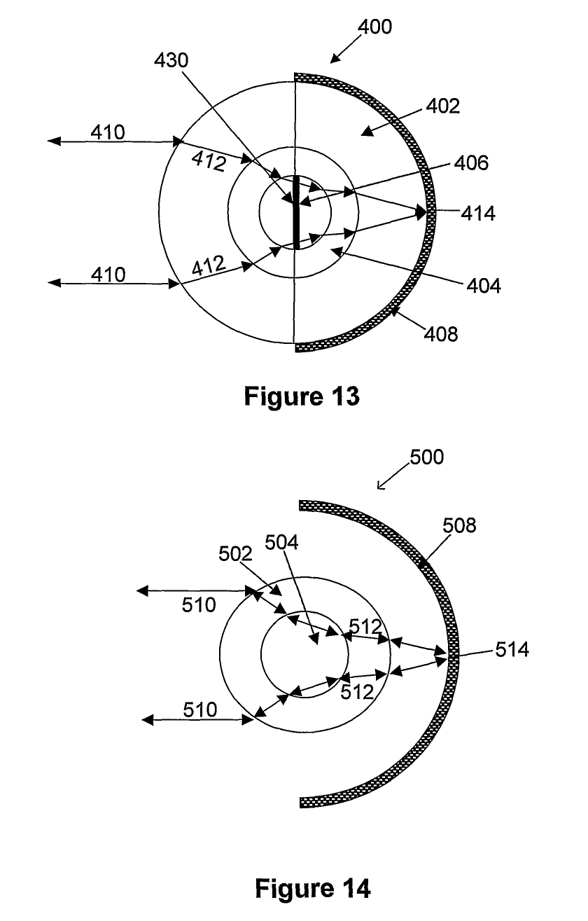

FIG. 13 is a schematic diagram of a three-layer modulated retroreflector in accordance with another embodiment of the present invention;

FIG. 14 is a schematic diagram of a two-layer retroreflector including an air gap and a hemispherical mirror formed in accordance with another embodiment of the present invention;

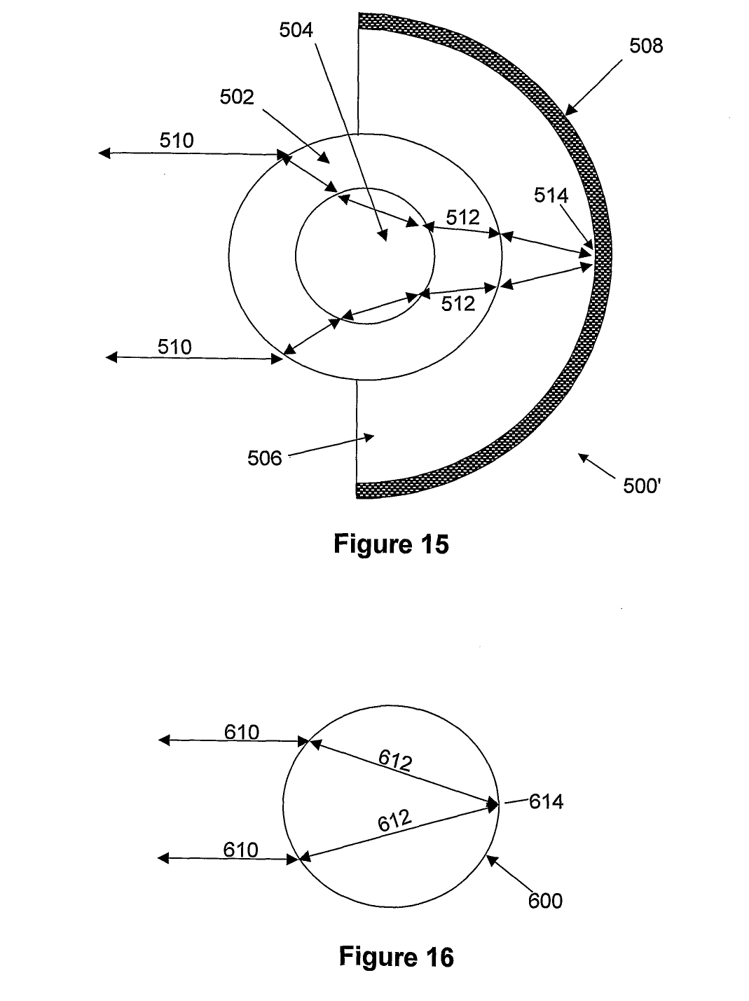

FIG. 15 is a schematic diagram of a retroreflector including a hemispherical mirror, a ball lense and a hemispherical lens in accordance with further embodiments of the present invention;

FIG. 16 is a schematic diagram of a single-layer retroreflector formed in accordance with an embodiment of the present invention;

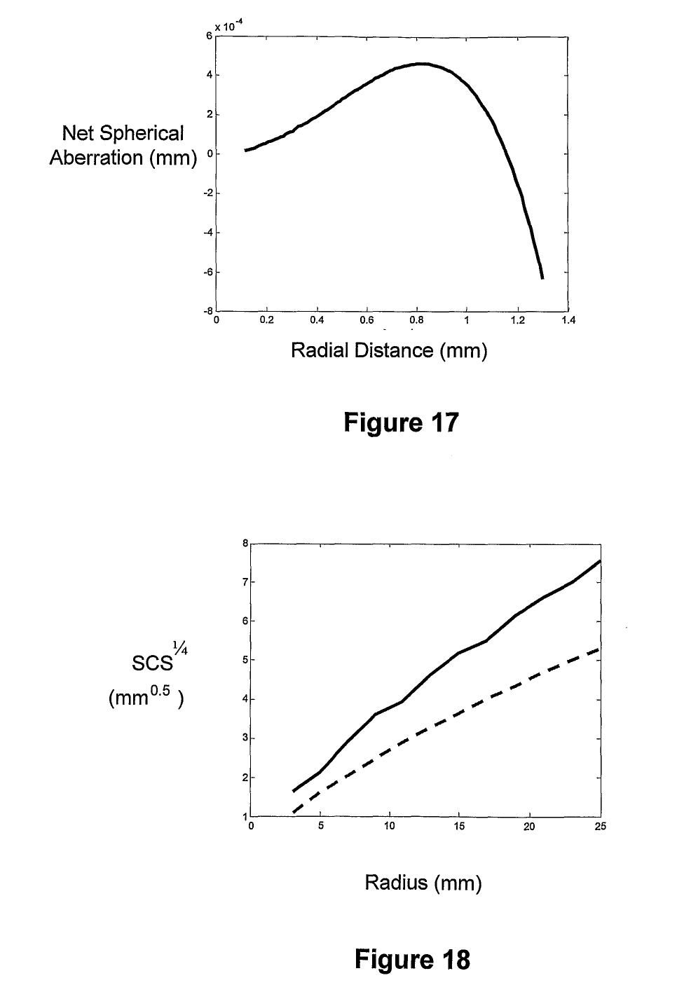

FIG. 17 is a graph indicating the spherical aberration as a function of radial distance across an example single-layer retroreflector of the type illustrated in FIG. 16; and

FIG. 18 is a graph indicating the fourth root of the scattering cross-section as a function of radius of a single layer retroreflector as illustrated in FIG. 16, illustrating how the embodiment retroreflector outperforms the previous “ideal” retroreflector across all indicated radii.

The present inventor has realised that the performance of spherical retroreflectors can be improved by correcting for spherical aberration. By controlling the geometry of the layer(s) of spherical retroreflectors, and by selecting materials of appropriate refractive index for the layer(s), the present inventor has realised that spherical aberration can be corrected for within such retroreflectors, increasing the performance of (i.e. magnitude of the reflected beam from) spherical retroreflectors. The correction for spherical aberration is ideally full correction, but it will be appreciated that any partial correction of spherical aberration can result in improved performance of the retroreflector. Correcting for spherical aberration within the retroreflector ensures that the radiation beam, at the point of reflection, has less longitudinal spherical aberration (preferably negligible), and hence reflects more efficiently.

For example, multi-layer retroreflectors can be formed that include a curved surface having a negative power, this curved surface then being used to correct the spherical aberration. The curved surface having a negative power can be formed at the interface between two of the layers of a multi-layer spherical reflector, by ensuring that the outermost layer has a higher refractive index. Such multi-layer retroreflector devices can be of a structure akin to the layers of an onion i.e. with each layer contacting one or more adjacent layers, such that the interface between adjacent layers of different refractive index will have an optical power. In most implementations, the external surface of the outermost layer can be coated with a partially reflective coating to enhance the performance of the retroreflector. Preferably, the partially reflective coating has a reflectivity of approximately one third for the electromagnetic radiation wavelength normally used with the retroreflector.

Such spherical retroreflectors do not require the use of expensive components/materials (e.g. components or materials having a refractive index of about two); it is therefore possible to construct devices having a relatively high performance at a reasonable cost using conventional optical materials and fabrication techniques.

The performance of a spherical reflector can be characterised by the scattering cross-section (SCS). The reference book by Weik, M. H., Communications Standard Dictionary, 1997, Chapman & Hall, defines the SCS as “the area of an incident wave front, at a reflecting surface or medium, such as an object in space, through which will pass radiant energy, that, if isotropically scattered from that point, would produce the same power at a given receiver as is actually provided by the entire reflecting surface”. The SCS is also referred to as the optical cross-section and the radar cross-section e.g. see Peebles P. Z., “Radar Principles”, John Wiley & Sons, New York, 1998.

The value of the SCS for retroreflectors at optical wavelengths is typically relatively large, because of the high directionality of the return beam. The SCS for a perfect circular mirror at normal incidence can be calculated using the Fraunhofer model of diffraction, as for instance described on page 396 of Born M. and Wolf E. “Principles of Optics (4th ed.)”, Pergamon Press, Oxford, 1970, as:

$$SCS = \frac{{π}^{3}}{4 {λ}^{2}} {d}^{4} [ {m}^{2} ] \qquad ( 1 )$$

where d is the diameter of the mirror and λ is the wavelength. For convenience d may be expressed in mm and λ in microns to give SCS in m². For example, a circular mirror of diameter 25 mm with a reflectivity of 100% provides an SCS of 7.57 km² at 632 nm.

The SCS of non-planar reflecting devices, such as the spherical reflectors described herein, can be predicted using numerical techniques. For example, an optical software design package can be utilised to compute the efficiency (Strehl ratio) of light emitted from a pre-defined entrance/exit pupil in the case of planar elimination. The Strehl ratio in such a context is the ratio between the actual intensity of the optical access and the intensity that would be produced by a mirror of the same aperture with a reflectivity of 100%. The SCS of a non-planar reflector can be estimated from the limiting value in equation (2) below.

$$SCS = {Lim}_{{}^{d} D} \frac{π}{4 {λ}^{2}} {d}^{4} S ( d ) , \qquad ( 2 )$$

where D is the diameter of the sphere and S(d) is the Strehl ratio computed for an exit pupil of diameter d. S(d) must be evaluated at a number of values for d in order to find the limit in equation (2). For small values of d, S(d) will have a value close to the overall reflective efficiency of the sphere (15%). As d becomes larger, S(d) will fall as 1/d⁴ due to optical aberration. The SCS is the limit of equation (2) for large d. The computation of S(d) must be sufficiently accurate to give convergence, and this typically requires that a relatively large number of rays must be traced (i.e. typically 10⁴).

Values of SCS as quoted herein have been calculated using the optical software design package Zemax™, a software package produced by the ZEMAX Development Corporation of Bellevue, Wash., USA.

FIG. 4 shows a two-layer spherical retroreflector 100 in accordance with a first embodiment of the present invention. The retroreflector comprises two concentric spherical layers 102, 104. Both layers 102, 104 are substantially transparent (at least at the wavelength of radiation of the beam with which it is intended to probe the retroreflector). The outer spherical layer 102 has an outer radius of r₁ and a refractive index n₁. The inner layer 104 is formed as a sphere of radius r₂ and refractive index n₂. The outer layer 102 is in contact with the inner layer 104 i.e. the inner radius of the outer layer is approximately the same as the outer radius of the inner layer. Preferably, an outer, partially-reflective coating 106 is provided extending around the outer surface of the outer layer 102, of reflectivity 33% and transmit 66%, so as to enhance the overall performance of the device.

In most implementations, to allow easy manufacturing of the retroreflector, the outer layer 102 will be formed in two or more segments. In the example shown in FIG. 4, the outer spherical layer 102 is formed of two hemispherical segments. The layer 104 is preferably formed of a single solid sphere, to prevent unwanted internal reflections within the retroreflector. Such a retroreflector can then be assembled by placing the segments of the outer layer 102 around the inner layer 104, and joining together the segments using standard techniques e.g. optical cement or diffusion bonding. Dotted lines 120 indicate the position at which the two outer hemispherical segments in FIG. 4 are joined together. In most applications, the inner radius of the outer layer will be very slightly larger than the outer radius of the inner layer, so as to allow the two layers to be coupled together e.g. using a push-fit assembly, optical cement or optical diffusion bonding.

It will be observed that the structure of the retroreflector 100 in FIG. 4 appears, prima facie, to be similar to the structure of the prior art retroreflector illustrated in FIG. 3.

However, the retroreflector in FIG. 4 is distinguished over the prior art retroreflector 30, by having an outer layer 102 having a higher refractive index than the inner layer 104 (i.e. n₁>n₂), such that the interface between the layers provides a curved surface of negative power for the spherical aberration correction. In the prior art device 30, the refractive index of the outer layer 32 is lower than the refractive index at the inner layer 34. The direct opposite effect will be hence be provided by the curved surface formed by the interface between the two layers 32, 34 of the prior art device 30, i.e. the interface will provide a curved surface having a positive optical power to radiation incident upon that device.

In the retroreflector 100, the relative radii r₁, r₂ and refractive indices of the materials forming the layers 102, 104 are selected such that light from a distant source is brought to a focus at a point 114 on the outer wall or surface of the device 100.

FIG. 4 shows a collimated beam 110 incident on the retroreflector 100 at a first position (on the left hand side of the retroreflector, as shown in the figure). The collimated beam is subsequently refracted (112) by the outer surface of the outer layer 102, and then refracted again along beam path 112 as it passes through the interfaces between the outer layer 102 and the inner layer 104, so as to be brought to a focus on the outer surface at a second position 114 opposite to the first position. The beam is then reflected at position 114, such that the beam returns along the same beam path 112 through the retroreflector, such that the output beam 110 from the retroreflector (i.e. the reflected beam from the retroreflector) is also collimated (110), and returns along the same path as the incident beam. Spherical aberration of the reflected beam can be measured from the mid point of the beam through a cross-section of the beam after the reflected beam leads the retro reflector i.e. along the radial distance from the beam centre indicated by Arrow 130.

The radii and the refractive indices are the correct values to bring the collimated beam to a focus on the outer wall if the below equation (3) is satisfied.

$$\frac{2}{{n}_{1}} + \frac{2 {r}_{1}}{{r}_{2} {n}_{2}} - \frac{2 {r}_{1}}{{r}_{2} {n}_{1}} = 1 \qquad ( 3 )$$

Ideally, the refractive indices and radii are also such that the retroreflector is fully corrected for spherical aberration. The third order spherical aberration is given by the expression −1/8*S₁h⁴, where S₁ is the first Seidel sum and h is the ray height. Further detail regarding the first Seidel sum can be found within the book by Welford W. T. “Abberations of the Symmetrical Optical System”, Academic Press, London, 1974.

For a unit ray height, the third order spherical aberration is given by equation (4) below. Ideally, values of radii and refractive index are selected such that the equation is zero i.e. so as to provide zero spherical aberration.

$$- \frac{1}{16 {r}_{1}^{3} {n}_{1}} + \frac{1}{16 {r}_{1}^{3}} + \frac{1}{8 {r}_{2}^{3} {n}_{1} {n}_{2}} - \frac{1}{8 {n}_{2}^{2} {r}_{2}^{3}} \qquad ( 4 )$$

Ideal solutions to both equations (3) and (4) are rarely found in real devices, as real optical materials (i.e. transparent materials of sufficient homogeneity and transparency to be utilised in optical devices) have discrete values of refractive index. The selection of materials (and hence the values of n₁ and n₂) is therefore limited, and in many instances it will be impossible to utilise materials for the layers of the retroreflector that have exactly the desired refractive indices to provide zero spherical aberration. Hence during the design process, taking into account the desired function of the retroreflector and the acceptable cost, materials will be selected that minimise the value of expression (4). Rarely will the relevant materials lead to the expression (4) being equal to zero. Table 1 below provides examples of suitable pairs of materials for the different layers 102, 104.

TABLE 1

| Material pair | Type B(i) | Type B(ii) | Type B(iii) |
|---|---|---|---|
| INNER SPHERE | Zinc Sulphide | Zinc Sulphide | Thallium Chloride |
| (104) | | | |
| OUTER LAYER | Zinc Selenide | GLS | Zinc Sulphide |
| (102) | | | |

The material GLS (Gallium/Lanthanum Sulphide) within materials pair B(ii) is a new chalcogenide glass, recently produced by the spin-off company ChG Southampton Ltd from the University of Southampton's Optoelectronics Research Centre. GLS has many desirable properties for use in retroreflectors as described herein, including it being hard enough to be handled easily without damage, and the fact that it can be hot-pressed into any required shape. Potentially, the outer layer(s) of retroreflectors (i.e. any layer surrounding an inner sphere) could be formed in one step, without requiring such outer layer(s) to be split into two or more segments (e.g. hemispherical sections) for assembly.

Once the material types have been chosen, then n₁ and n₂ are generally fixed. The designer then has control over only one parameter, r₂/r₁, so as to satisfy equation (3), and hence give zero primary aberration (i.e. zero defocus). The graph shown in FIG. 5 shows r₂/r₁ as a function of n₁. The third order spherical aberration of the retroreflector then depends on the values of n₁ and n₂. FIG. 6 shows a plot of ideal values of n₁ and n₂ that give exactly zero third order spherical aberration, with three additional points plotted corresponding to the actual values of n₁ and n₂ for the three material pairs indicated in table 1. Preferably, material pairs are selected that lie as close as possible (taking into account cost and other design considerations) to the plotted line in FIG. 6, so as to minimise the zero third order aberration provided by the dual-layer retroreflector.

Further analysis has indicated that it is generally better to choose material pairs that fall just below the curve within FIG. 6, rather than material pairs which fall above the curve. This allows the residual spherical aberrations to be partially corrected by design optimisation i.e. by altering values of r₁ and r₂ away from the values indicated in equation (3) and in FIG. 5 i.e. selecting the inner radius such that a slight primary defocus further compensates for the residual spherical aberration.

For example, a device of external diameter (r₁) 25.0 mm formed using the materials pair B(iii) would, according to equation (3), ideally have an inner radius (r₂) of 9.087 mm. The predicted SCS from ray tracing for this configuration is 15,700 m². However, if the inner radius (r₂) is reduced slightly, to 8.970 mm, then the SCS is actually increased to 70,000 m². The graph in FIG. 7 shows the performance of such a retroreflector formed from materials pair B(iii) in terms of the ray aberration from this device at the operating wavelength of 690 mm i.e. the spherical aberration experienced in the direction 130 indicated across the reflected beam 110 in FIG. 4. It is useful to compare the optical power of the active surfaces in the device. It is well-known that the optical power, in dioptres, of a spherical lens is given by the change in refractive index at the surface divided by the radius of curvature in metres. At the outer surface the refractive index changes from approximately 1.0 (air) to 2.33 (ZnS), a change of +1.33. Since the radius is 25.0 mm the power is 53.2 dioptres. At the inner surface the change in index is from 2.33 to 2.2, a change of −0.13. The inner radius is 8.79 mm so the optical power is −14.5 dioptres. The ratio between negative and positive power in this example is 27.2%.

Similarly, taking an outer diameter of 25.0 mm as the starting point, for materials pair B(i) the inner radius calculated using equation (3) would be 8.5998 mm, giving an SCS of 10,300 m². However, if the radius is increased to 8.6162 mm, then the SCS becomes 40,000 m². Further, for materials pair B(ii), the inner radius calculated using equation (3) would be 5.9006 mm, giving an SCS of 2000 m². However, if the radius r₂ is increased to 5.9024 mm, then the SCS is increased to 2,800 m². The relatively low values of SCS for pair B(ii) indicate that ideally any material pair should have refractive indices that are closer to the curve in FIG. 6.

For comparison, it should be realised that the SCS of even the material pair B(ii) is better than the performance of known prior art spherical retroreflectors. For example, the SCS of the 50 mm spherical reflector described with reference to FIG. 1 has been calculated as only 1033 m², whilst the SCS of the 60 mm two-layered device described with reference to FIG. 3 is only 1,500 m².

FIG. 8 illustrates a spherical retroreflector 200 in accordance with a second embodiment of the present invention. The retroreflector 200 comprises three concentric spherical layers. Use of three layers provides greater control over third-order spherical aberration correction, but leads to slightly greater manufacturing complexity (as the third layer has to be added). However, the degree of freedom provided by three layers allows a greater selection of materials to be utilised, i.e. potentially allowing cheaper materials to be utilised. Again, preferably the outer surface of the outer layer 202 is covered by a partially reflective coating 208 to enhance the reflectivity of the retroreflector. The part-reflective coating preferably reflects 33% of incident light and transmits 66%.

As previously, a collimated incident radiation beam 210 will be refracted by the different layers (beam shown by arrows 212) to be focussed at a point on the outer wall 214 of the retroreflector 200. The beam will be reflected position 214, back along the incident path (212, 210). Spherical aberration of the reflected beam compared with the incident beam can be measured as a function of radial distance, in the reflected beam at the position indicated by Arrow 230.

If the (outer) radii of the layers 202, 204, 206 are denoted respectively by r₁, r₂ and r₃, and the refractive indices by n₁, n₂ and n₃, then the ray height at the reflected surface (position 214) should be zero i.e. the condition expressed by equation (5) should be met.

$$\frac{2}{{n}_{1}} + \frac{2 {r}_{1}}{{r}_{2} {n}_{2}} - \frac{2 {r}_{1}}{{n}_{1} {r}_{2}} + \frac{2 {r}_{1}}{{r}_{3} {n}_{3}} - \frac{2 {r}_{1}}{{r}_{3} {n}_{2}} = 1 \qquad ( 5 )$$

[It should be noted that, in three-layer devices within the claims, slightly different denotations are utilised than above, for consistent terminology between two layer and three layer devices; in particular, in the claims, the middle layer (204) is indicated as having radius r₁ and refractive index n₁, the inner layer (206) radius r₂ and refractive index n₂, and the outer layer (202) refractive index n₃ and r₃ i.e. a three layer device can be regarded as a two layer device, within the addition of an outer layer of relatively low refractive index]

An advantage of the three-layer configuration is that, with suitable choice of materials, more than one set of values of r₂/r₁ and r₃/r₁ will satisfy the requirement of equation (5). The values for r₂/r₁ and r₃/r₁ can be chosen to control the spherical aberration and hence maximise the SCS of the device using conventional iterative techniques of optical lens design. An iterative technique is best, as the expression for third-order spherical aberration of this three-layer type of retroreflector is relatively lengthy e.g. it can be given by the expression:

2/r3/r2̂2/n2̂2/n1+1/r3/r2/n2̂2/r1−2/r3̂2/n2̂2/n3/r2+1/r3̂2/n2/n3/r1

−1/r3/r2/n2̂2/r1/n1−1/r3̂2/r2/n1/n3̂2+1/r3/r2̂2/n1̂2/n3

−1/r3/r2/n1̂2/n3/r1+1/r3/r2/n1/n3/r1−1/r3/r2̂2/n1̂2/n2

+1/r3/r2/n1̂2/n2/r1−1/r3/r2/n1/n2/r1+1/2/r3̂2/r1/n1/n3̂2

+1/4/r3/r1̂2/n1̂2/n3−1/2/r3/r1̂2/n1/n3−1/4/r3/r1̂2/n1̂2/n2

+1/2/r3/r1̂2/n1/n2−1/r2̂2/n1̂2/n2/r1−1/r3̂2/n1/n2̂2/r2

+2/r3̂2/n2/n3/r2/n1−1/4/r2̂3/n1̂3−1/r3̂2/n2/n3/r1/n1

+1/r3̂2/r2/n2/n3̂2+1/r3/r2̂2/n2̂2/n3−2/r3/r2̂2/n2/n3/n1

+1/r3/r2/n2/n3/r1/n1−1/r3/r2/n2/n3/r1+1/4/r2̂3/n2̂3

−1/r2̂3/n1/n2̂2+1/r2̂3/n1̂2/n2+1/2/r2̂2/n1̂3/r1

−1/2/r2̂2/n1̂2/r1−1/4/r2/r1̂2/n1̂3+1/2/r2/r1̂2/n1̂2

+1/r2̂2/n1/n2/r1+1/2/r2̂2/r1/n1/n2̂2+1/4/r2/r1̂2/n1̂2/n2

−1/2/r2/r1̂2/n1/n2−1/2/r2̂2/r1/n2̂2+1/4/r2/r1̂2/n2

−1/4/r2/r1̂2/n1−1/4/r3̂3/n2̂3+1/4/r3̂3/n3̂3+1/2/r3̂2/r1/n1/n2̂2

+1/r3̂2/n2̂3/r2−1/r3̂3/n2/n3̂2+1/r3̂3/n2̂2/n3−1/r3/r2̂2/n2̂3

−1/2/r3̂2/r1/n3̂2+1/4/r3/r1̂2/n3−1/4/r3/r1̂2/n2−1/2/r3̂2/r1/n2̂2

+1/8/r1̂3/n1−1/8/r1̂3/n1̂2

As previously, the outer radius (r₁) of the spherical retroreflector can be selected as desired. Using the above expression, the radii of the inner surfaces (r₂ and r₃) could be chosen to minimise third-order spherical aberration, but a design technique based on iterative ray-tracing is preferred. Such ray-tracing allows a non-zero value for primary and third-order spherical aberration to be used to balance higher order terms, thus minimising further the spherical aberration provided by the device, and maximising the SCS of the resulting retroreflector.

An example 3-layer device is now described in detail for use at a wavelength of 690 nm. Three glasses, BK6, STF2 and TF10, are selected from the GOST-RUS standard range (e.g. see “GlassBank” at www.ifmo.ru). The thermal expansion properties of these glasses are compatible. The nominal refractive indices of these glasses at 690 nm are computed using the catalog Sellmeier coefficients as 1.5361396, 1.9265330 and 1.7937143 respectively. Samples of the glasses were obtained and the actual refractive indices measured at wavelengths of 587, 643 and 706 nm. Refractive index interpolation using the linear model described in Langenbach E. “Melt Dependent Refractive Index Interpolation for Optical Glasses”, Paper number 3737-06, SPIE Proceedings: Design and Engineering of Optical Systems II, Berlin, 1999 gives the estimated refractive indices at 690 nm as: 1.5368, 1.9273 and 1.7926 respectively. The optical design shown in Table 2 was then produced using an iterative ray-tracing method.

TABLE 2

| | | |
|---|---|---|
| Inner Section (206): | Glass type: | Radius: |
| | TF10 | 10.188 +/− 0.001 mm |
| Middle Section (204): | Glass type: | Outer radius: |
| | STF2 | 16.244 +/− 0.001 mm |
| Outer Section (202): | Glass type: | Outer radius: |
| | BK6 | 35.000 +/− 0.005 mm |

The joints were glued with high-index optical cement, and the outer section (BK6) coated with a ¼ wave TiO₂ part-reflective coating

The aberration performance for this design is shown in FIG. 9. The calculated SCS is 26,389 m² or 0.026 km² at 690 nm. The (approximate) optical power of the outer surface is 15.3 dioptres, that of the middle surface is 23.7 dioptres and that of the innermost surface is −12.9 dioptres. The ratio between the negative power and the total positive power (39) of the active surfaces of the retroreflector is 33%.

This device was fabricated and tested in conjunction with a commercially available survey instrument (Sokkia SET3 230RM). A range of detection exceeding 1,500 metres was achieved. This represents adequate performance for many applications. The correction offset value for distance measurement (to obtain the centre of the sphere as if it were in free space) is −82.52 mm.

Following manufacture of the above sample, the inventor realised that the radii and tolerances could have been further optimised. Further, the part-reflective outer coating 208 should preferably have had a reflectivity of around 33%, rather than the 20% or so provided by the ¼ wavelength TiO₂ coating. For example, better performance could have been provided by using a multilayer dielectric coating such as a three-layer ¼ wavelength TiO₂/SiO₂/TiO₂ coating. Alternatively, a thin metal coating of appropriate thickness could have been utilised. Finally, performance of the three-layer device could have been further improved by utilising an anti-reflective coating on the surface of the middle layer 204 formed of STF2.

In the above example, the band width of the retroreflector is relatively limited, and hence it is desirable to only utilise the device in conjunction with a collimated radiation beam of wavelength 690 nm. In some applications, it may be preferable that the retroreflector is arranged for operation at more than one wavelength of incident radiation.

In many applications, it is preferable that the device is suitable for working over a reasonably wide temperature range.

FIG. 10 illustrates a suitable three-layer device 300. It will be observed that the device structure is generally the same as that indicated within FIG. 8 i.e. the retroreflector 300 includes three concentric spherical rays 302, 304, 306 having radii r₁, r₂, r₃ and refractive indices n₁, n₂ and n₃ respectively. The path 312 of the incident beam to the reflection position 314 is illustrated. Arrow 330 indicates the radial distance along which the resulting spherical aberration at the two operational wavelengths (690 nm and 830 nm) is illustrated in FIG. 12.

For ease of manufacture, the two outer layers 302, 304 are each formed from hemispherical sections, which are joined together by optical cement along joint 322.

The materials forming the layers are chosen to give optimum performance at two wavelengths rather than one. In other words, as per the retroreflector indicated in FIG. 8, the retroreflector indicated in FIG. 10 must also satisfy equation (5), as well as the corresponding condition regarding spherical aberration. However, such criteria need to be satisfied at two different wavelengths, rather than one. Further, the material selection for the layers is such that the change in refractive index with temperature is approximately compensated so that the device can be used over a reasonably wide temperature range. The condition for temperature compensation (also known as the athermal condition) is expressed by equation (6), in which T is the temperature.

$$\frac{1}{{n}_{1}^{2}} ( \frac{{r}_{1}}{{r}_{2}} - 1 ) ( \frac{\partial {n}_{1}}{\partial T} ) + \frac{{r}_{1}}{{n}_{2}^{2}} ( \frac{1}{{r}_{3}} - \frac{1}{{r}_{2}} ) ( \frac{\partial {n}_{2}}{\partial T} ) - \frac{{r}_{1}}{{r}_{3} {n}_{3}^{2}} ( \frac{\partial {n}_{3}}{\partial T} ) = 0 , \qquad ( 6 )$$

Although the device is described for operation at the wavelength pair of 690 nm and 380 nm, it will be appreciated that the same procedure could be used to design reflectors for other pairs of wavelengths of electromagnetic radiation e.g. in both the visible and infrared ranges.

The outer layer (302) is formed from S-TIL6 optical glass from Ohara. The middle layer (304) is Zinc Selenide sublimate ceramic (ZnSe) and the inner layer (306) is S-LAH79 optical glass from Ohara. The inner sphere (306) is formed by joining two hemispheres since glass of the required thickness to make a complete ball is not commercially available. This joining (320) is achieved using optical diffusion bonding rather than cement to avoid problems with internal reflection. The refractive index values for these materials at different temperatures are given below, in table 3, and the corresponding radii of each layer (including design tolerances) within table 4.

TABLE 3
Material Data
S-LAH79 Melt

| Temper- | 690 ZEMAX | 830 ZEMAX | | |
|---|---|---|---|---|
| ature | new cat −2005 | new cat −2005 | 690 actual | 830 actual |
| 15° C. | 1.98900251 | 1.97753823 | 1.98904751 | 1.97761823 |
| 20° C. | 1.98905143 | 1.97758657 | 1.98909643 | 1.97766657 |
| 25° C. | 1.98910002 | 1.97763460 | 1.98914502 | 1.97771460 |

ZnSe (ceramic)

| Temper- | | | | |
|---|---|---|---|---|
| ature | 690 ZEMAX | 830 ZEMAX | 690 actual | 830 actual |
| 15° C. | 2.56033425 | 2.51627449 | 2.56053425 | 2.51647449 |
| 20° C. | 2.56064824 | 2.51658061 | 2.56084824 | 2.51678061 |
| 25° C. | 2.56096178 | 2.51688631 | 2.56116178 | 2.51708631 |

TIL6 melt

| Temper- | 690 ZEMAX | 830 ZEMAX | | |
|---|---|---|---|---|
| ature | new cat −2005 | new cat −2005 | 690 actual | 830 actual |
| 15° C. | 1.52716083 | 1.52326070 | 1.52704083 | 1.52314070 |
| 20° C. | 1.52717217 | 1.52327194 | 1.52705217 | 1.52315194 |
| 25° C. | 1.52718327 | 1.52328294 | 1.52706327 | 1.52316294 |

TABLE 4

| | |
|---|---|
| Outer Section (302): | 35.00000 +/− 0.005 mm |
| Middle Section (304): | 20.39703 +/− 0.001 mm |
| Inner Section (306): | 13.13946 +/− 0.001 mm |

The SCS for this device is 0.427 km² at 690 nm and 0.377 km² at 830 nm. A scale ray-trace drawing for this device is shown in FIG. 11, and the resulting aberration performance in FIG. 12. The (approximate) optical power of the outer surface is 15.1 dioptres, that of the middle surface is 50.5 dioptres and that of the innermost surface is −43.5 dioptres. The ratio between the negative power and the total positive power is 66%.

From the above teachings, it will be apparent that various alternative embodiments will fall within the scope of the present invention. For example, although only two and three layer devices are described above, it should be appreciated that devices could be formed having other number of layers. A spherical retroreflector could be formed having four or more concentric spherical layers, allowing potentially improved device performance/greater selection of different materials but at the cost of increased manufacturing complexity.

Equally, the basic structure outlined herein could be modified. For example a retroreflector could incorporate a modulator structure, arranged to modulate the radiation beam. Such a modulator could be a passive modulation structure such as a fixed grating, or could be an active modulation structure e.g. incorporating a layer of nematic liquid crystal, with the orientation of the liquid crystal being controlled by applying a voltage to adjacent electrodes so as to modulate the incident radiation beam. The article “Large-aperture multiple quantum well modulating retroreflector for free-space optical data transfer on unmanned aerial vehicles”, by G. C. Gilbreath et al, Optical. Engineering, volume 40, number 7, pp 1348-1356, 2001, describes suitable modulator structures.

The possibility of providing a partially reflective coating to the outer surface of the outer layer has been described. However, if desired, a fully reflective coating (e.g. reflectivity 90% or greater, more preferably substantially 100%) could be provided as a covering a portion of the outer surface (e.g. as a hemispherical coating) so as to increase the reflectivity of the retroreflector, but decrease the acceptance angle.

FIG. 13 indicates a three-layer retroreflector 400 including a modulation layer 430 and a hemispherical mirror 408, provided in the form of a coating on the outer surface. As previously, the device includes three layers (402, 404, 406), with incident radiation 410 being refracted as the radiation 412 passes through the retroreflector, to reflect that a position 414 opposite to the entry position of the beam to the retroreflector. Modulator structure 430 is indicated in this particular embodiment as being positioned in a plane passing through the centre of the inner layer 406. Although the mirror 408 has been described as being provided by a coating, it will be appreciated that the mirror could simply be a hemispherical mirror positioned adjacent to the outer layer 402.

Alternatively, a hemispherical mirror could be positioned at a predetermined distance from the outer layer. FIG. 14 shows such a retroreflector 500. The retroreflector 500 includes a two-layer spherical device 502, 504, in combination with a hemispherical mirror 508. It will be readily appreciated that the device is, in many ways, generally similar to the device illustrated in FIG. 13, but with the outer layer 402 of the device in FIG. 13 instead replaced with an air gap (i.e. the gap between the outer layer 502 and the hemispherical mirror 508). If such a device is utilised in space, then the gap between the mirror and the outer layer 502 could be a vacuum. As previously, the path of an incident radiation beam (510, 512) through the device is illustrated, up to and including the position 514 at which it reflects from the hemispherical mirror.

Alternatively, instead of having a vacuum gap or an air gap between the hemispherical mirror, it will be appreciated that a material (i.e. a transparent material of uniform refractive index) could be placed between the two-layer spherical device and the hemispherical mirror. FIG. 15 shows a device 500′ including such a hemispherical refractive element 506. Identical reference numerals are utilised to represent similar features as illustrated in FIG. 14. As per FIG. 14, the central sphere 504 has a lower refractive index than the outer spherical layer 502, so as to provide the desired curved surface having a negative power between the two layers 502, 504.

In the embodiments illustrated in FIGS. 14 and 15, the radii of layers 502, 504 will be selected so as to ensure that the incident beam 510 is focussed at the position 514.

The present inventor has appreciated that spherical aberration can be corrected for within retroreflectors, so as to improve the performance of the retroreflector. As indicated above, this spherical aberration correction can be performed by providing a curved surface having a negative optical power. Equally, the inventor has appreciated that spherical aberration can be at least partially corrected for by selecting the dimensions of the device such that spherical aberration is compensated for by primary defocus. Such a technique can be used in conjunction with the use of a negative curved surface (i.e. in two or more layer retroreflectors), or can be used on its own within a single layer optical device.

In other words, the radius of a device can be selected such that the spherical aberration is corrected for by primary defocus. This allows the provision of relatively efficient single layer retroreflectors (e.g. a ball lens, or retroreflectors in the form of a sphere of material) that are formed from relatively cheap optical materials e.g. materials that have a refractive index less than the previously thought “ideal” value of 2.0. In this way, the optical performance of the reflector is actually enhanced by spherical aberration.

FIG. 16 illustrates such a single layer retroreflector 600, which is formed as an uncoated 8.0 mm diameter sphere of optical glass S-LAH79, providing an SCS of around 8.8 m² at a wavelength of 690 nm. The path of an incident ray (610, 612) to and from the point of reflection 614 is illustrated in the Figure.

If the device 600 is coated with a layer having a reflectivity of 33%, then the SCS increases to 13.2 m². The wave aberration at a wavelength of 690 nm is illustrated in FIG. 17, as a function of radial displacement. In the prior art, it was assumed that the ideal glass for providing such a single layer device had a refractive index of 2.00. However, compared to the single layer embodiment, if an ideal glass with a refractive index of exactly 2.00 was used, then such an “ideal” device would have a significantly worse performance i.e. an SCS of only 3.1 m² assuming the device was coated with a 33% reflective material.

Such small devices 600 are useful for surveying at distances of up to around 200 metres. In tests by the present inventor, uncoated devices of diameter 8.0 mm have produced consistent distance measurement results at distances in excess of 200 metres using commercially available instruments (Sokkia SET3 230RM). It is appreciated that similar ranges could be achieved using small pieces of reflective sheets, but the advantage of using a spherical retroreflector is that the return beam originates from a single point, leading to significantly better accuracy and measurement applications.

The useful range of this type of reflector will vary according to the fourth root of the SCS in most applications. The simplest way to increase the range is to scale up the device. The fourth root of SCS is shown plotted against the device radius in FIG. 18. The solid trace shows the simulation result for S-LAH79 at 690 nm and the dotted trace shows the result for an “ideal” material of refractive index exactly 2.0. A 33% part-reflective coating is assumed. Both materials give a near-linear increase in range with radius. The S-LAH79 gives significantly better performance due to compensation for spherical aberration. The main limiting factor in size is the cost of the glass and the practical difficulties in producing thick slabs of highly homogenous high-index glass. The thickest strip of S-LAH79 that is currently available is 17.0 mm thick. The largest sphere that could be fabricated from this stock would have a radius of around 8.0 mm; this would give an SCS of approximately 81 m².

1. A retroreflector comprising at least two concentric spherical layers, a first of said layers being of uniform refractive index n₁ surrounding a second of said layers of uniform refractive index n₂, wherein the refractive indices satisfy the criteria n₁>n₂.

2. A retroreflector as claimed in claim 1, wherein the second layer is a sphere.

3. A retroreflector as claimed in claim 1, wherein said concentric spherical layers provide a negative optical power to incident radiation of a predetermined wavelength to compensate for spherical aberration.

4. A retroreflector as claimed in claim 1, further comprising a reflective coating of predetermined thickness located on the external surface of the outermost of said layers.

5. A retroreflector as claimed in claim 1, further comprising a partially-reflective coating of predetermined thickness extending uniformly around the complete outer surface of the outermost of said layers.

6. A retroreflector as claimed in claim 1, wherein said concentric spherical layers are dimensioned such that collimated radiation incident on an outer surface of the retroreflector at a first position is brought to a focus on an outer surface of the retroreflector at a second position opposite to the first position.

7. A retroreflector as claimed in claim 6, wherein said first and second positions are located on the external surface of the outermost of said layers.

8. A retroreflector as claimed in claim 1, further comprising a concave reflective surface positioned a predetermined distance from the outermost concentric layer.

9. A retroreflector as claimed in claim 8, wherein said concave reflective surface is a hemispherical reflector having a radial centre concentric with said spherical layers.

10. A retroreflector as claimed in claim 1, further comprising a concave reflective surface positioned a predetermined distance from the outermost concentric layer, wherein said concentric spherical layers are dimensioned such that collimated radiation incident on an outer surface of the retroreflector at a first position is brought to a focus on an outer surface of the retroreflector at a second position opposite to the first position, said second position is located on said concave reflective surface.

11. A retroreflector as claimed in claim 1, wherein said at least two concentric spherical layers consists only of first and second layers, the first layer having an external radius of r₁ and the second layer having an external radius of r₂, which satisfy the criteria
$$\frac{2}{{n}_{1}} + \frac{2 {r}_{1}}{{r}_{2} {n}_{2}} - \frac{2 {r}_{1}}{{r}_{2} {n}_{1}} \approx 1$$
$$and \\ - \frac{1}{16 {r}_{1}^{3} {n}_{1}} + \frac{1}{16 {r}_{1}^{3}} + \frac{1}{8 {r}_{2}^{3} {n}_{1} {n}_{2}} - \frac{1}{8 {n}_{2}^{2} {r}_{2}^{3}} \approx 0.$$

12. A retroreflector as claimed in claim 1, further comprising a third of said layers having a uniform refractive index n₃ surrounding the first of said layers, wherein the refractive indices satisfy the criteria n₁>n₂>n₃.

13. A retroreflector as claimed in claim 12, wherein said at least two concentric spherical layers consist only of the first, second and third layers, the first layer having an external radius of r₁, the second layer having an external radius of r₂, and the third layer having an external radius of r₃, the refractive indices and radii of said layers being arranged to provide a predetermined degree of spherical aberration compensation.

14. A retroreflector as claimed in claim 1, further comprising at least a third and a fourth of said concentric layers.

15. A retroreflector as claimed in claim 1, wherein the retroreflector has a scattering cross section of at least 5,000 m².

16. A retroreflector as claimed in claim 1, wherein the retroreflector comprises one or more surfaces with a total negative optical power of greater than 10% of the total positive power.

17. A retroreflector as claimed in claim 1, wherein said criteria is satisfied for at least two different wavelengths of incident radiation.

18. A retroreflector as claimed in claim 1, wherein the materials forming said layers substantially satisfy the athermal condition over a predetermined temperature range.

19. A retroreflector as claimed in claim 1, further comprising an optical modulator arranged to modulate incident radiation.

20. A method of manufacturing a retroreflector comprising at least two concentric spherical layers, the method comprising:
providing a first spherical layer of uniform refractive index n₁ around a second spherical layer of uniform refractive index n₂, wherein the refractive indices satisfy the criteria n₁>n₂.

21. A method as claimed in claim 20, further comprising the steps of:
calculating the radii and refractive indices of said concentric layers required to provide a predetermined degree of at least one of spherical aberration compensation and scattering cross-section; and
forming the layers having the calculated radii and refractive indices.

22. A method of operation of a retroreflector comprising at least two concentric spherical layers, a first of said layers being of uniform refractive index n₁ surrounding a second of said layers of uniform refractive index n₂, wherein the refractive indices satisfy the criteria n₁>n₂, the method comprising:
directing a radiation beam to reflect from the retroreflector; and
measuring a predetermined property of the radiation beam reflected from the retroreflector.

23. A retroreflector comprising a sphere having a predetermined refractive index and radius such that spherical aberration is at least partially compensated for by primary defocus.

24. A retroreflector as claimed in claim 23, wherein the sphere is formed of S-LAH79 optical glass.

25. A retroreflector as claimed in claim 23, wherein the sphere has a radius of less than 6 mm.

26. A retroreflector as claimed in claim 23, wherein the sphere has a scattering cross-section of at least 5 m².

27. A method of manufacturing a retroreflector comprising a sphere, the method comprising:
designing a sphere to have a predetermined refractive index and radius such that spherical aberration is at least partially compensated for by primary defocus; and
manufacturing the designed sphere.

28. A method of operation of a retroreflector comprising a sphere having a predetermined refractive index and radius such that spherical aberration is at least partially compensated for by primary defocus, the method comprising:
directing a radiation beam to reflect from the retroreflector; and
measuring a predetermined property of the radiation beam reflected from the retroreflector to determine the position of the retroreflector.

29. A spherical retroreflector, comprising at least one concentric spherical layer, the values of the refractive index and radius of each of said at least one layer correcting for spherical aberration within the retroreflector for incident radiation of predetermined wavelength.
